(19) United States
(12) Patent Application Publication
(10) Pub. No.: US 2014/0362436 A1
(43) Pub. Date: Dec. 11, 2014

(54) AUTOMATIC SLIDE LOADING SYSTEM AND METHOD

(71) Applicant: Clemex Technologies Inc., Longueuil (CA)

(72) Inventor: Clément Forget, Boucherville (CA)

(21) Appl. No.: 14/299,692

(22) Filed: Jun. 9, 2014

Related U.S. Application Data
(60) Provisional application No. 61/832,239, filed on Jun. 7, 2013.

(51) Int. Cl. G01N 35/00; G02B 21/26

(52) U.S. Cl. CPC G01N 35/00029; G02B 21/26; G01N 2035/00039
USPC 359/391

(57) ABSTRACT

A microscopy slide loading system includes a motorized cassette having a plurality of stacked slots for supporting microscopy slides and a motorized loading arm being displaceable between a retracted position and a loading position. The loading arm projects through a slide slot of the cassette to push a slide positioned therein, eject the slide from the cassette and load the slide onto a slot of a slide holder of a microscope. Loading of the slide into the slide holder allows analysis of the slide by the microscope. After analyzing the slide, a front portion of the loading arm having gripping fingers grip the slide and pulls the slide from the slide holder back into the cassette in order to reload the slide into the cassette. Another slide of the cassette can be loaded and unloaded in a similar manner.

### RELATED PATENT APPLICATION

The present application claims priority from provisional patent application No. 61/832,239, filed Jun. 7, 2013 and entitled “AUTOMATIC SLIDE LOADING SYSTEM AND METHOD”, the disclosure of which is incorporated by reference herein in its entirety.

### FIELD

The present subject-matter relates to an automatic slide loading system and method, and more particularly to slide loading system and method that displaces a slide through a cassette onto a slide holder to load the slide for analysis.

### INTRODUCTION

Microscopes are commonly used for conducting research, quantitative characterization and screening in various applications, such as semi-conductors fabrication, pharmaceutical research, biomedical and biotechnology laboratories, and aerospace and automotive parts manufacturing. The measurement of attributes characterizing the elements present in microscopic images, finds applications in materials science and in pharmaceutical and biotechnological research.

In various situations, it may be desirable to use a microscope to analyze samples in bulk. These situations may arise, for example, in the analysis of multiple blood films in a hospital or similar clinic or laboratory setting. (A blood film, or peripheral blood smear, is drawn onto a microscope slide and then stained or otherwise treated in a way to allow the various blood cells to be examined microscopically. Blood films are used to test for hematological disorders and sometimes to test for other illnesses and conditions.) Having an automated microscope capable of automated image analysis of samples in combination with an automatic slide loader allows a large quantity of slides to be analyzed quickly and without requiring human intervention.

U.S. Pat. No. 6,847,481 describes a slide handler that automatically transfers glass microscope slides from a cassette or magazine to a motorized microscope stage and then returns the slide back into the cassette. The use of this instrument permits the unattended computer control, measurement and inspection of specimens mounted to the slides. Full modular integration of the system components allows for the slide handler instrument to be utilized with any microscope. The instrument system has a minimum of three components; namely a slide cassette indexer, an XY-stage, and a slide exchange arm. The indexer, the arm and the XY-stage are connected together and integrated into one unitary modular instrument that can be moved from one microscope to another.

U.S. Pat. No. 7,948,676 describes an automated cassette and slide handling system which organizes microscope slides in cassettes, automatically and sequentially removes individual slides from their respective cassettes, positions each slide under the microscope as provided by the protocol, and after examination returns the slide to its proper cassette.

U.S. Pat. No. 5,659,421 describes a slide positioning and holding device includes a base, a number of first bearing members defining a bearing surface for slidably engaging a first edge of the slide, at least one second bearing member for slidably engaging a second edge of the slide generally perpendicular to the first edge, and first and second arms for contact with the third and fourth edges of the slide to urge the first and second edges of the slide into contact with the bearing members.

U.S. Pat. No. 4,024,966 describes a photographic slide magazine placed on a hub that rotates around its axis while compartments containing slides pass over an opening through which the slides drop into a receiver. After unloading previously stored slides each compartment passes under a loading mechanism, which drops another slide into each of the emptied compartments. Loading and unloading operations are concurrent. A storage magazine with a clamping mechanism is used to pick-up the unloaded slides and to place the slides in the loading mechanism.

United States publication no. 2012/0218400 describes a microscopic image pickup apparatus for acquiring images of specimens on slide glass samples includes a slide holder pickup section by which the whole image of a slide holder on which a plurality of slide glass samples are arrayed is acquired, a slide glass sample macro-pickup section by which whole images of the slide glass samples are acquired, a slide glass sample micro-pickup section by which micro images of specimen areas of the slide glass samples are acquired under predetermined imaging conditions, and an imaging process control section generating a slide glass sample information management screen. The slide glass sample information management screen is displayed such that the array of display areas for displaying imaging conditions-setting means for setting imaging conditions and for displaying whole images of slide glass samples is paralleled with the array of slide glass samples on a slide holder.

The automatic slide loading systems mentioned above have various disadvantages, such as being complicated, expensive and/or bulky.

### SUMMARY

The following summary is intended to introduce the reader to the more detailed description that follows, and not to define or limit the claimed subject matter.

According to a first aspect, the present subject matter provides a microscopy slide loading system for loading slides from a cassette having a plurality of slots supporting the slides to a microscope having an automated movable stage. The slide loading system includes: a bracket upon which the cassette can be mounted; an automated loading arm that can be displaced from a retracted position to an extended position; an automated actuator for moving the cassette on the bracket to align a selected microscope slide supported in one of the slots of the cassette with the loading arm; a slide holder mounted to the stage of the microscope; the stage being movable to a slide loading position; a fixation for connecting the slide loading system to the microscope such that the slide holder is aligned to receive the selected slide as it is displaced outwardly from the cassette by the loading arm being displaced from its retracted position to its extended position when the stage is in the slide loading position; the stage being movable to a slide viewing position, and subsequently movable to a slide unloading position that is substantially the same as the slide loading position; the loading arm also having a retraction element for attaching to the slide so as to be able to pull the slide back from the slide holder into the cassette as the arm is returned to its retracted position when the stage is in the slide unloading position.

According to another aspect, the present subject matter provides a microscopy slide loading system that includes a motorized cassette having a plurality of stacked slots for supporting microscopy slides, and a motorized loading arm being displaceable between a retracted position and a loading position, during displacement from the retracted position to the loading position the loading arm projecting at least partially through an aligned slot of the cassette to displace a slide positioned therein to eject the slide from the cassette.

According to yet another aspect, the present subject matter provides a microscope stage that includes a slide holder portion having a slide holder slot having a frontal opening defined by opposite side walls, a rear wall and a slide retaining member and a motorized movable portion for displacing the slide holder portion between a slide loading position and a slide retaining position, in the slide loading position the slide retaining member being actuated to a first position to allow loading and unloading of a slide in the slide holder slot through the frontal opening and in the slide retaining position the slide retaining member being actuated to a second position to retain a loaded slide in the slide holding slot.

According to yet another aspect, the present subject matter provides a method for loading and unloading slides to and from a microscope. The method includes aligning a first slot of a cassette holding a first slide to be analyzed with a loading arm, displacing the slide holder of a microscope stage to a slide loading position to align a front opening of a slide holder slot of the slide holder with the loading arm, displacing the loading arm toward the microscope stage through a rear opening of the cassette to engage a slide supported in the aligned slot of the cassette and to push the slide through a front face of the cassette and through the front opening of the slide holding slot of the holder, displacing the slide holder to a slide examining position to align the slide in the slide holding slot with an active objective of the microscope, and after examining the slide, displacing the slide holder of the microscope stage to the slide loading position to align the front opening of the slide holding slot of the slide holder with the loading arm, gripping the slide with the loading arm, displacing the loading arm away from the microscope stage to pull the slide into the aligned slot of the cassette, and further displacing the loading arm away from the microscope stage to disengage the loading arm from the cassette.

### DRAWINGS

For a better understanding of the embodiments described herein and to show more clearly how they may be carried into effect, reference will be made, by way of example only, to the accompanying drawings in which:

FIG. 1 is a side elevation view of a microscopy unit having a microscope with an automated slide loading system according to one exemplary embodiment;

FIG. 2 is a perspective view viewed from the front of a slide cassette that could be used with the slide loading system of FIG. 1;

FIG. 3 is a perspective view of the slide cassette of FIG. 2 viewed from the rear;

FIG. 4 is a close-up perspective view of a loading arm and slide cassette portion of the slide loading system of FIG. 1;

FIG. 5 is another close-up perspective view of the loading arm and slide cassette portion of FIG. 4;

FIG. 6 is a close-up perspective view of the loading arm and slide cassette of FIGS. 4 and 5, with a slide holder;

FIG. 7 is a detailed elevation side view of the loading arm of FIGS. 4-6;

FIG. 8A is a detailed elevation side view of the loading arm of FIG. 7 engaging a slide in a pushing interaction

FIG. 8A is a detailed elevation side view of the loading arm of FIG. 7 engaging a slide in a gripping interaction;

FIG. 9 is a top section view of a microscope having a movable stage according to one embodiment;

FIG. 10 is a close-up perspective view of a microscope stage and slide holder of the microscope of FIG. 9;

FIG. 11A is a detailed perspective view of the slide holder of FIG. 10;

FIG. 11B is a detailed perspective view of a slide holder according to an alternative exemplary embodiment;

FIG. 12 is a top view of the microscopy unit of FIG. 1;

FIG. 13 is a schematic diagram illustrating the steps of an exemplary method for carrying out automated slide loading and unloading and analysis of slides.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

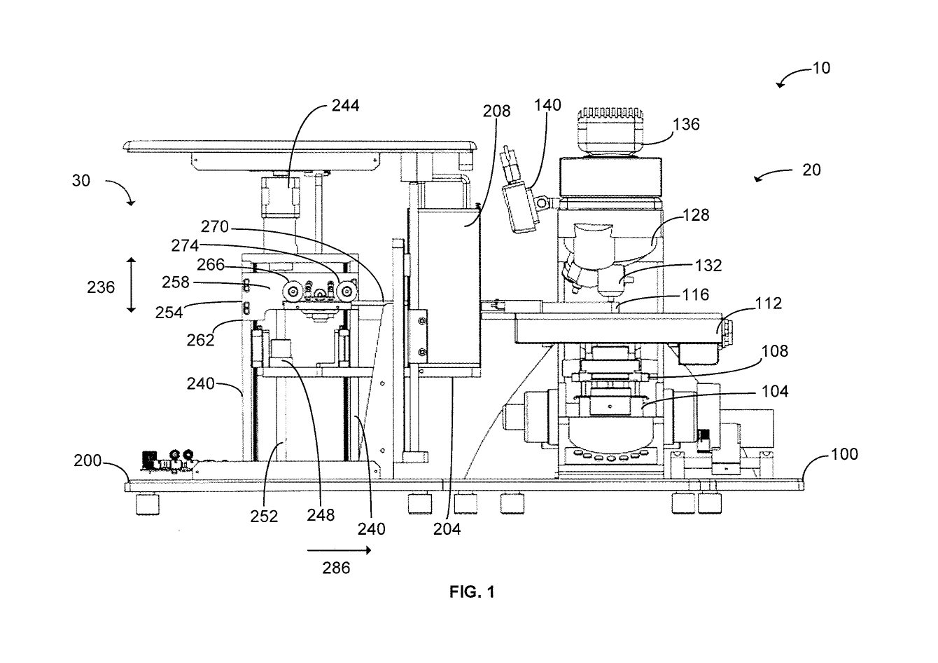

Referring to FIG. 1, therein illustrated is an elevation view of a microscopy unit 10 according to one exemplary embodiment. The microscopy unit 10 includes a microscope 20 and an automatic slide loading system 30.

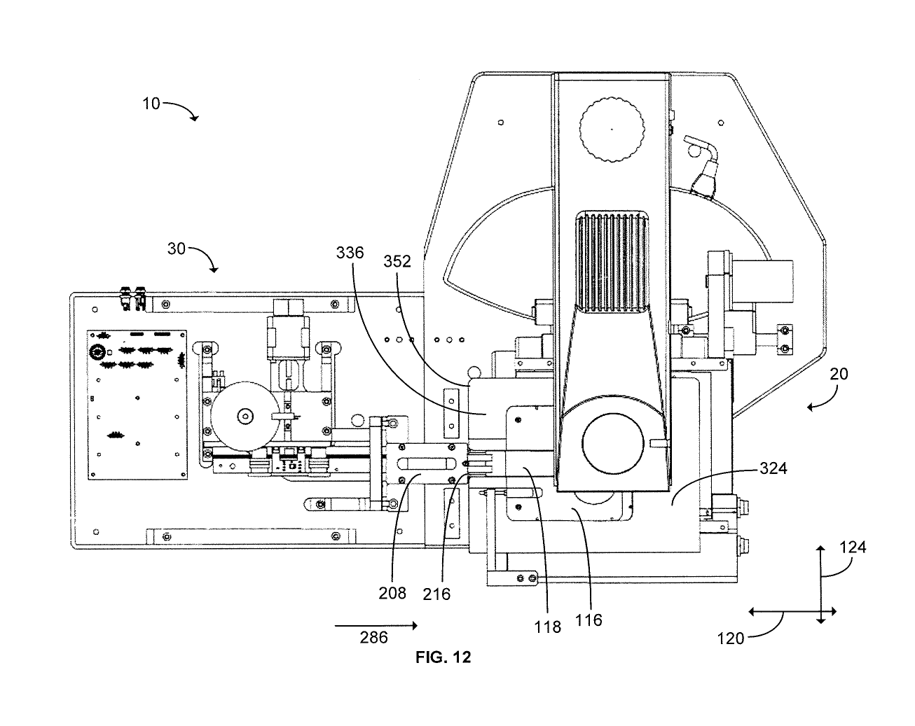

The microscope 20 has a microscope base 100. The microscope 20 further includes a light source 104 for illuminating the sample to be analyzed, a diaphragm 108 for modulating the amount of light from the light source 104 that is shone upon the sample, and a stage 112. A slide holder 116 is mounted on the stage 112. The slide holder 116 can hold a slide 118 (FIG. 12), upon which is carried a sample to be analyzed. The stage 112 is motorized and is operable to move the slide holder 116 within at least a horizontal plane parallel to the underlying surface defined by the base 100 of the microscope 20. For example, the stage 112 can have a first motor for moving the slide holder 116 in the x-axis direction 120 (FIG. 12) and a second motor for moving the slide holder 116 in a y-axis direction 124.

The microscope 20 further includes a turret 128 having mounted thereon one or more objective lenses 132. The turret 128 is rotatable to allow selection of an active objective lens. The active objective lens corresponds to the lens that is positioned above the diaphragm 108 and light source 104 and that can be used to analyze the sample of the slide 118.

In some cases, an eyepiece is aligned with the active objective lens to allow viewing of the sample through the eyepiece as magnified by the active objective lens objective lens 132.

The exemplary embodiments has a computerized microscope 20, with an imaging system 136 positioned at the turret 128 used to view and/or analyze the sample as magnified by the objective lens 132. The imaging system 136 can include a camera, such as a CCD or CMOS camera, for obtaining digital images of the sample as magnified by the objective lens 132.

According to some embodiments, the microscope 20 further includes a slide identification system 140, which can be used to read an identifier of the slide 118 being held in the slide holder 116. For example, each of the slides 118 may include a bar code and the slide identification system 140 is a bar code reader. Advantageously, the slide identification system 140 allows for automatic identification of the slide 118. This is particularly useful where a batch of slides 118 is being analyzed and each slide 118 needs to be machine-identified.

Continuing with FIG. 1, the slide loading system 30 has a slide loading base 200. For example the slide loading base 200 can be attached to the microscope base 100 in order to join the slide loading system 30 with the microscope 20. However according to other exemplary embodiments the slide loading system 30 can be detached from the microscope 20 to allow the microscope 20 to be operated alone. Alternatively the slide loading system 30 can be joined to other types of microscopes 20 to work in conjunction with them.

The slide loading system 30 includes cassette support brackets 204 for receiving and supporting at least one slide cassette 208.

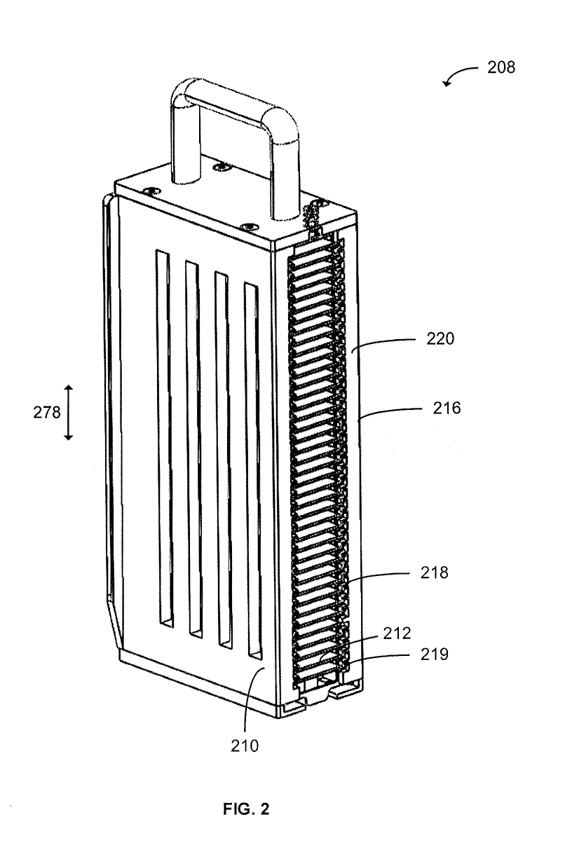

Referring now to FIG. 2, therein illustrated is a perspective view of the slide cassette 208 viewed from the front of the cassette 208. The cassette 208 includes a plurality of transverse members 209 extending from opposing sidewalls 210. The plurality of transverse members 209 are positioned in a stacked arrangement to define a corresponding number of slide slots 212 that are also stacked. Microscopy slides 118 to be analyzed can be inserted into the vertically stacked slide slots 212. For example the cassette 208 can be removable from the slide loading system 30 such that slides 118 to be analyzed can be loaded and unloaded from the cassette 208 at a location remote from the microscope slide loading system 30. This may be useful for preparing slides 118 to be analyzed and loading them into the cassette 208 at a convenient location prior to the slide analysis by the automated microscopy unit 10. The removable cassette 208 can be removed and reinserted to be supported within support brackets 204 of the slide loading system 30.

Continuing with FIG. 2, a front face 216 of the cassette 208 is at least partially open to allow insertion and ejection of microscopy slides 118 inserted in the slide slots 212. According to the exemplary embodiment, the front face 216 has a front wall 220 partially obstructing the slide slots 212 of the cassette 208. The front wall 220 can be displaced over the front face 216 between a slide obstructing position and a slide access position. In the slide access position, slides 118 can be inserted and removed from the cassette 208 through a lengthwise gap defined by the front wall 220. In the slide obstructing position, the front wall 220 partially blocks access to the slide slots 212 through the front face 216 to prevent insertion and removal of slides 118. For example, the front face 216 can have a plurality of projections extending transversely from a side of the front wall 220 into the gap defined by the front wall 220. In the slide obstructing position, the transverse projections align with the slide slots 212 to prevent insertion and removal of slides 118. In the slide access position, the transverse projections are displaced away from the slide slots 212 to allow access to the slide slots 212. The position of the front wall 220 can be controlled, for example, according to the position of the cassette 208 within support brackets 204 or according to a height of the cassette 208 above the base 200.

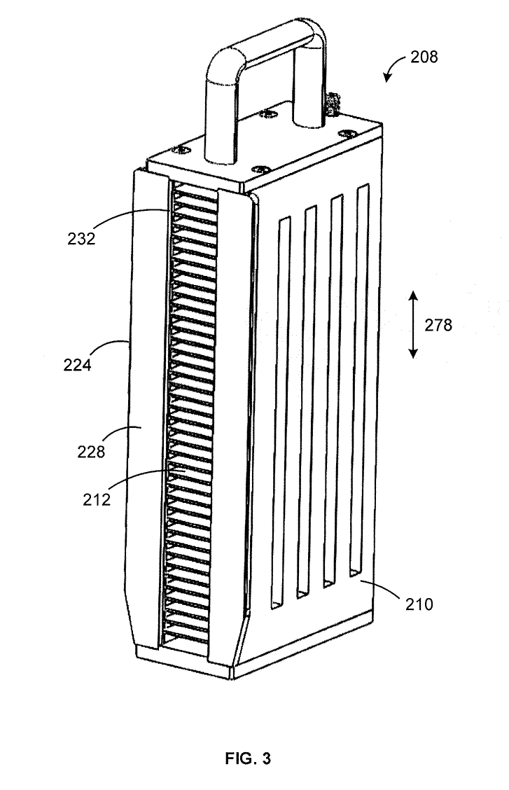

Referring now to FIG. 3, therein illustrated is a perspective view of the cassette 208 from the rear. A rear face 224 of the cassette 208 is at least partially open along the stacked direction of the cassette 208. For example at least one rear wall 228 extends along the stacked length of the cassette 208 between the top and a bottom of the cassette 208. Two rear walls 228, each contacting an opposed sidewall 210 of the cassette 208 and extending along the stacked length of the cassette 208, define a rear opening 232 on the rear face 224 of the cassette 208. The width of rear opening 232 is narrower than the width of a slide 118 inserted in slide slots 212, and therefore rear wall 228 restricts insertion and removal of the slide 118 through the rear face 224 of the cassette 208.

Referring back to FIG. 1, the movable support brackets 204 are movable in at least a vertical direction 236 toward and away from the slide loading base 200. It will be understood that the vertical direction corresponds to the direction of the vertically stacked slots 212 of the cassette 208. Vertical movement of the support brackets 204 causes vertical movement of the cassette 208 supported therein such that slots 212 of the cassette 208 can have varying heights.

The movable support brackets 204 can be attached to upstanding members 240 of a support frame and the support brackets 204 can be movable along a length of the upstanding members 240. The upstanding members 240 can act as guides or have tracks to define the displacement of the support brackets 204.

The slide loading system 30 includes a first motor 244 attached to the support brackets 204 for controlling vertical movement of the member 212. For example, a connector 248 of the support brackets 204 is connected to a shaft 252 of the first motor 244. For example, the shaft 252 can be an externally threaded shaft threadedly attached to internal threads of the connector 248. Rotation of the threaded shaft 252 by the first motor 244 in either direction causes the support bracket, 204 to be raised or lowered, thereby further causing the cassette 208 to be raised or lowered.

The microscope slide loading system 30 further includes a motorized loading arm 254 positioned at a height above the base 200. For example, the motorized loading arm 254 can be mounted on the upstanding members 240 such that the motorized loading arm 254 is positioned at a predetermined height above the base 200.

According to one exemplary embodiment, the loading arm 254 can be adjustably mounted on the upstanding members 240 to vary the height of the loading arm 254 above the base 200. Adjustment of the height of the loading arm 254 allows adapting of the slide loading system 30 according to different types of microscope 20 to be used with it. The loading arm 254 can be mounted onto a support bracket 258 having connectors 262 for selective mounting of the support bracket 258 to the upstanding members 240 at various heights above the base 200. Adjustment of the height of the loading arm 254 can be performed manually or controlled by a second motor.

The motorized loading arm 254 includes a third motor 266 attached to an extended arm member 270. For example, the third motor 266 can cause wheels 274 to turn about an axis parallel to the base 200. The wheels 274 can frictionally engage a portion of the extended arm member 270 to cause displacement of the extended arm member 270. For example the extended arm member 270 is displaceable in a direction transverse to the stacked direction of the stacked slots 212.

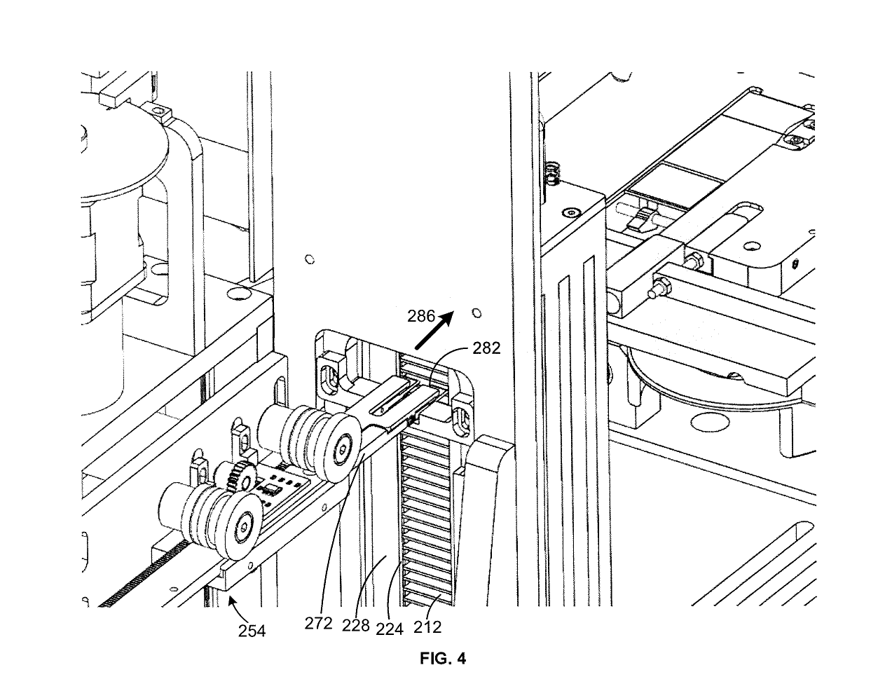

The extended arm member 270 of the motorized loading arm 254 is displaceable between at least a retracted position and an extended position. Referring now to FIG. 4, therein illustrated is the extended arm member 270 of the motorized loading arm 254 having been displaced to the retracted position. In the retracted position, the extended arm member 270 is disengaged from the cassette 208. For example there is at least a small gap between the forward edge 282 of the extended arm member 270 and the rear face 224 of the cassette 208. Since the extended arm member 270 is disengaged from the cassette 208 when in the retracted position, the cassette 208 can be moved in a vertical direction in relation to the base 200. Therefore when the extended arm member 270 of the motorized loading arm 254 is in the retracted position, the cassette 208 can be moved to allow a selection of a given slot 212 of the cassette 208 for analysis of a slide 118 being held within that slot 212.

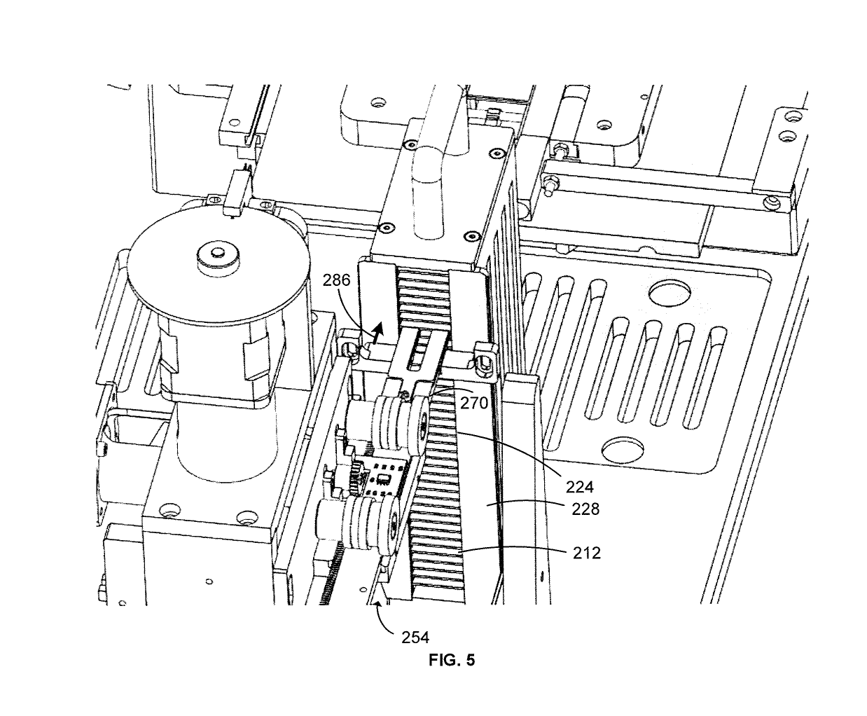

The extended arm member 270 can be displaced in a forward direction defined by vector 286 from the retracted position towards the cassette 208 to reach its extended position. As the extended arm member 270 is displaced in the forward direction, the front forward edge of the extended arm member 270 projects through the partially open rear face 224 and enters into an aligned slot 212 of the cassette 208. Referring now to FIG. 5, therein illustrated is a perspective view wherein the extended arm member 270 has been displaced to an intermediate position between its retracted position and its extended position. In the intermediate position as shown, the forward edge 282 of the extended arm member 270 has entered into the aligned slot 212 of the cassette 208 through the rear face 224 of the cassette 208. It will be appreciated that transverse insertion of a portion of the extended arm member 270 into the aligned slot 212 restricts the vertical movement of the cassette 208. In various exemplary embodiments, the first motor is controlled to cease movement of the cassette 208 when the extended arm member 270 is in the intermediate position or extended position.

“Aligned slot” herein refers to a slide slot 212 of the slide cassette 208 that has been selected according to the vertical position of the cassette 208. The aligned slot 212 can receive the extended arm member 270 in that slot 212 as the extended arm member 270 is displaced towards its extended position. For example the aligned slot 212 will have substantially the same height above the base 200 as the height of the extended arm member 270 of the loading arm 254 above the base 200. It will be appreciated that which of the slots 212 is the aligned slot 212 at any time can be selectively adjusted by varying the vertical position of the cassette 208.

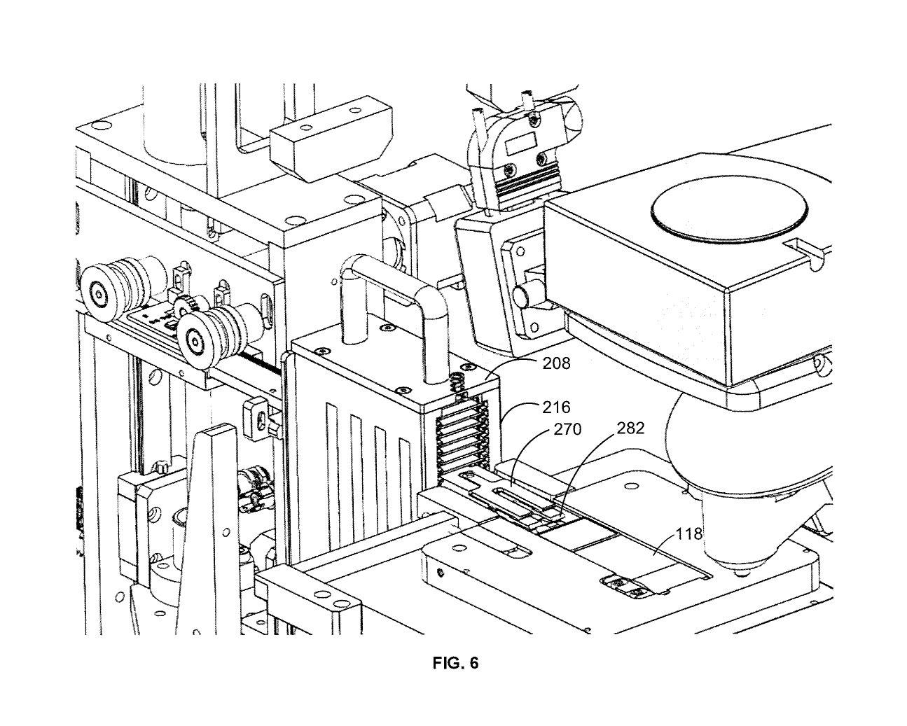

Referring now to FIG. 6 therein illustrated is the extended arm member 270 of the loading arm 254 having reached its extended position. During displacement from the retracted position to the extended position, the forward edge 282 of the extended arm member 270 engages a microscopy slide 118 supported in the aligned slot 212 of the cassette 208. Forward movement of the extended arm member 270 between the retracted position and the extended position and engagement of the forward edge 282 of the extended arm member 270 with the slide 118 supported within the aligned slot 212 results in the extended arm member 270 pushing the slide 118 through the aligned slot 212 in the direction of the front face 216 of the cassette 208. Further forward displacement of the extended arm member 270 towards its extended position causes the slide 118 to be ejected from the cassette 208 through the front face 216.

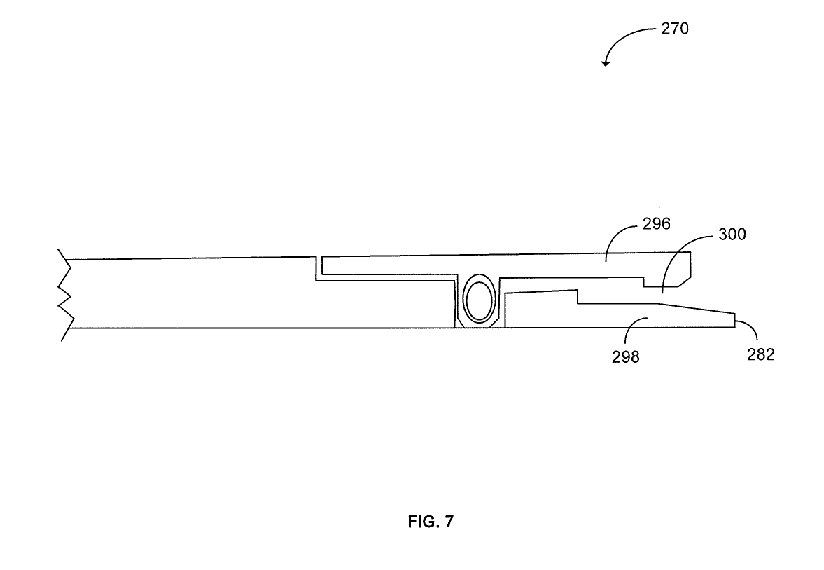

Referring now to FIG. 7, therein illustrated is an elevated side view of extended arm member 270 of the motorized loading arm 254 according to some exemplary embodiments. The front portion of the extended arm member 270 can have a retraction element, such as gripping fingers, for engaging a microscopy slide 118.

When being displaced from its retracted position to its extended position, a portion of the gripping fingers engages the microscopy slide 118 supported in the aligned slot 212. Forward displacement of the extended arm member 270 then displaces the slide through the aligned slot 212 towards the front face 216 of the cassette 208.

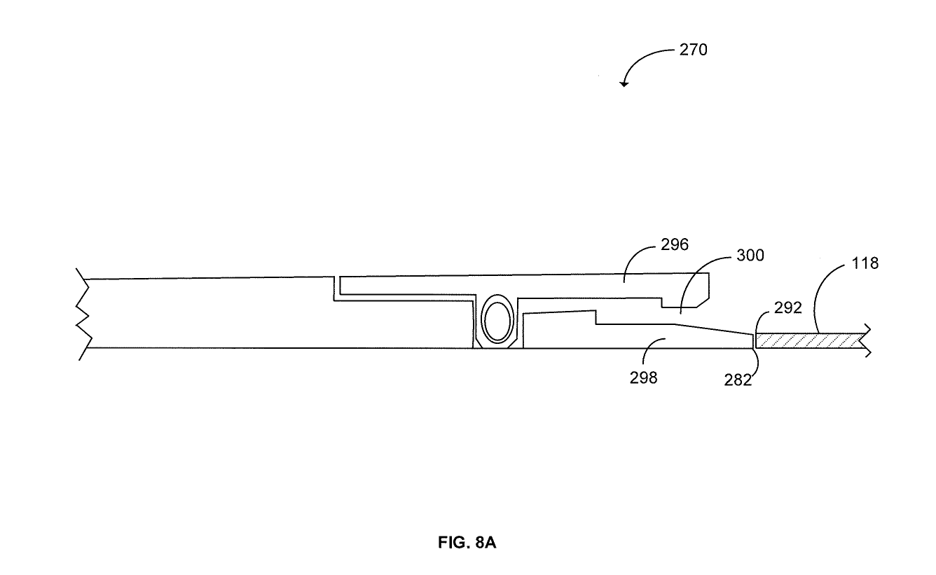

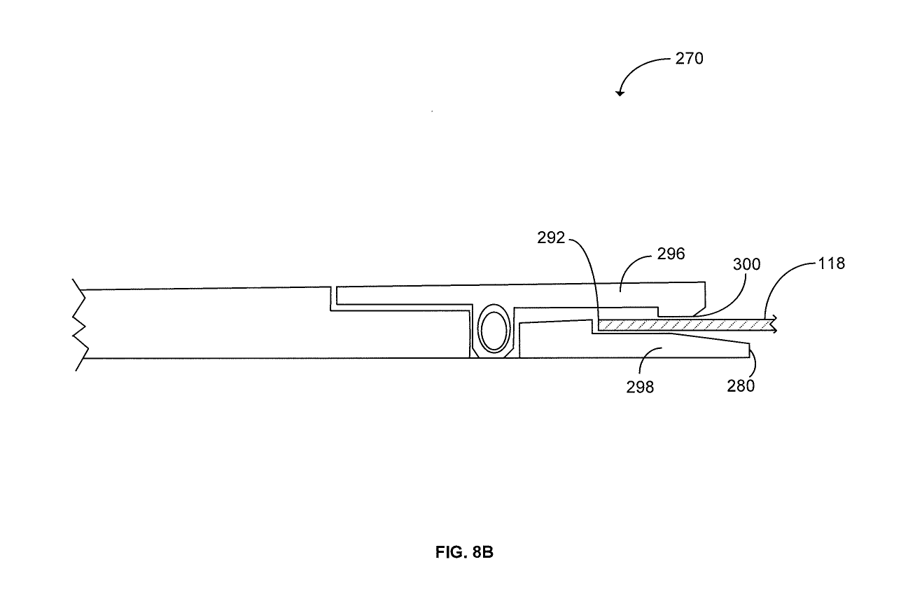

According to one exemplary embodiment, and as shown in FIG. 8A, when being displaced from its retracted position to its extended position, a forward edge 282 of the gripping fingers, which can correspond to the forward edge 282 of the extended arm member 270, abuts against a rearward edge 292 of the microscopy slide 118 supported in the aligned slot 212. Forward displacement of the extended arm member 270 thereby pushes the slide 118 through the aligned slot 212 towards the front face 216 of the cassette 208.

Continuing with FIGS. 7, 8A and 8B, the gripping fingers can include an upper member 296 and a lower member 298. At least one of the upper member 296 or the lower member 298 can be a spring member, biased towards the other such member. In some cases, both the upper member 296 and the lower member 298 can be spring members. It will be understood that “spring member” can encompass a substantially rigid member that is attached to the extended arm member 270 by an elastic attachment such that the spring member is biased towards the other member but can also be moved away from the other member under force.

According to various exemplary embodiments when in the biased position, the upper member 296 and the lower member 298 define a gap 300. The height of the gap 300 may be expanded to be sufficiently large to accommodate the height of a rearward edge 292 of the slide 118.

According to the exemplary embodiment wherein the forward edge 282 of the gripping fingers abuts the rearward edge 292 of the microscopy slide 118 to push the slide 118 through the aligned slot 212, the spring member and the other member remain biased towards one another when the forward edge 282 of the extended arm member 270 is pushing the slide 118 through the aligned slot.

Referring now to FIG. 8B, therein illustrated is an elevated side view of the extended arm member 270 of the motorized loading arm 254 according to some exemplary embodiments. When a sufficient force is applied onto a surface of the spring member in the rearward direction, opposite the forward direction 286, the spring member will be displaced away from its biased position and away from the other member. The biasing force of the spring member can be chosen based on the force in the rearward direction required to move the spring member away from the other member. A force applied by a rearward edge 292 of the microscopy slide 118 in the rearward direction causes the spring member to be moved and the microscopy slide 118 to be positioned between the upper member 296 and the lower member 298. A biasing force of one spring member towards the other member is thus applied on the surface of the slide and causes the upper member 296 and the lower member 298 to grip, or pinch, the microscopy slide 118.

The extended arm member 270 can be rearwardly displaced from its extended position back to its retracted position. During rearward displacement back to its retracted position, the extended arm member 270 can engage the microscopy slide 118 and pull the slide through the aligned slot towards the rear face 224 of the cassette 208. During the pulling motion, the upper member 296 and the lower member 298 of the gripping fingers of the extended arm member 270 grip the slide, which can be initially external to the cassette 208 when the extended arm member 270 begins its displacement from its extended position towards its retracted position. As the extended arm member 270 is displaced away rearwardly, the microscopy slide 118 is pulled by the extended arm member 270 and is reinserted into the aligned slot 212 of the cassette 208. Further rearward displacement of the extended arm member 270 towards its retracted position results in the forward edge 282 of the extended arm member 270 being positioned proximate the rear wall 228 of the cassette 208. The rearward edge 292 of the slide 118 being pulled by the extended arm member 270 abuts against an inner surface of the rear wall 228 of the cassette 208. Due to the above abutment of the rearward edge 292 of the microscopy slide 118 against the rear wall 228, release of the slide 118 by the gripping fingers of the extended arm member 270 due to abutment of the slide 118 against the rear wall 228 of the cassette 208 causes the slide 118 to be deposited within the aligned slot of the cassette 208 in a position wherein the rearward edge 292 of the slide 118 is proximate the rear wall 228 of the cassette 208. Further rearward displacement of the extended arm member 270 results in the forward edge 282 of the extended arm member 270 being exited from the cassette 208 through the rear face 224 of the cassette 208 such that the extended arm member 270 is disengaged from the cassette 208.

According to an alternative exemplary embodiment, the gripping fingers also frictionally grip or pinch the microscopy slide 118 when being displaced from its retracted position to its extended position. Accordingly, forward displacement of the extended arm member 270 thereby displaces the slide 118 through the aligned slot 212 towards the front face 216 of the cassette 208.

According to the exemplary embodiment wherein the slide 118 is frictionally gripped between the gripping fingers during forward displacement of the extended arm member 270, and as illustrated in FIG. 8B, the rearward edge 292 of the slide 118 is positioned beyond the gap 300 and between the upper member 296 and the lower member 298.

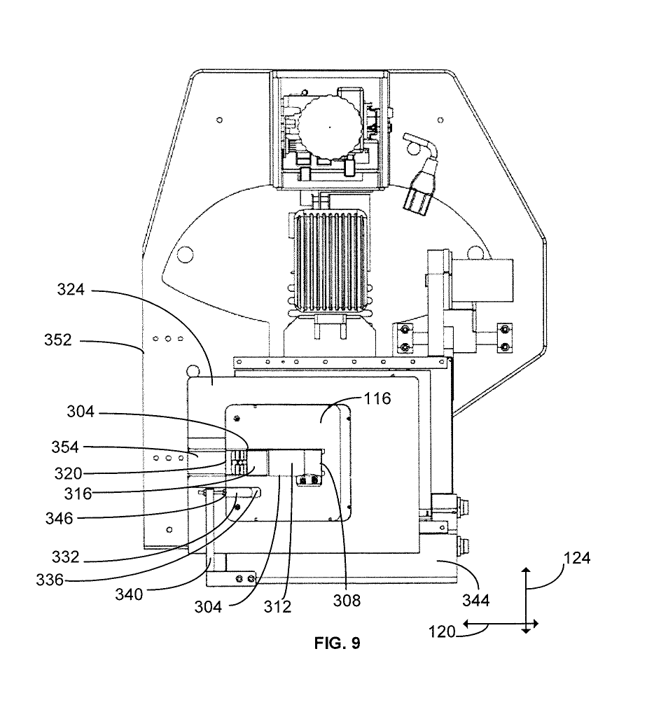

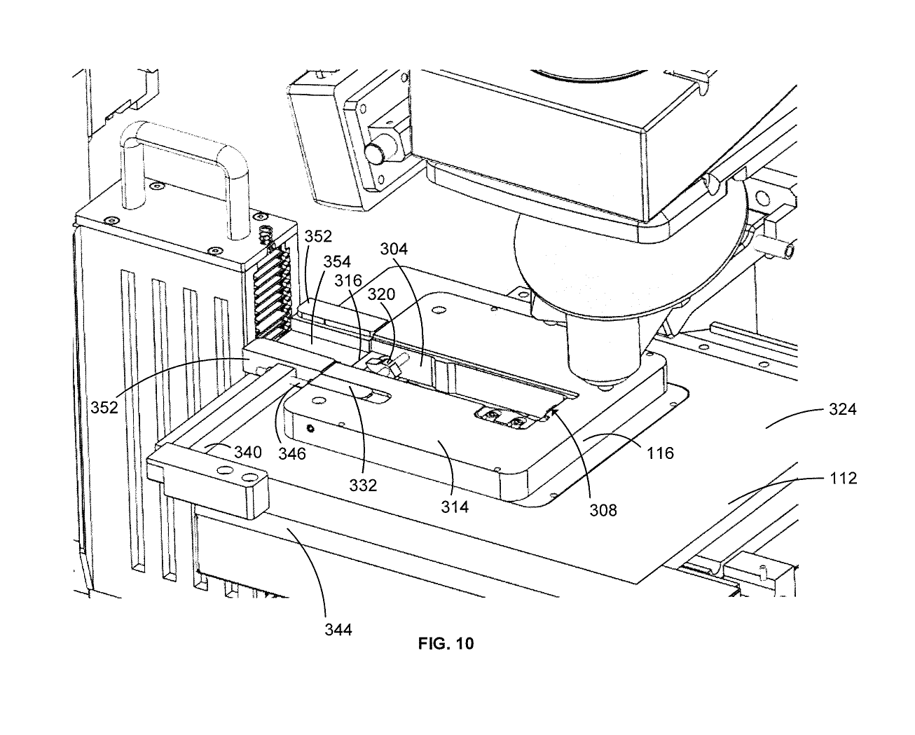

Referring now to FIGS. 9 and 10, therein illustrated is a plan view and a perspective view respectively of the microscope stage 112 having mounted thereon the slide holder 116. Slide holder 116 has interior opposing sidewalls 304 and an interior rear wall 308, which together define a slide holder slot 312. The slide holder slot 312 can be a recessed slot wherein the opposing sidewalls 304 and the rear wall 308 extend downwardly from an upper surface 314 of the slide holder 116. Opposing sidewalls 304 and rear wall 308 can have inward projections extending from a lower portion of the walls to support a bottom surface of a microscopy slide 118 such that the slide 118 is positioned in an upper portion of the slide holder slot 312. Alternatively, opposing sidewalls 304 and rear wall 308 can be upstanding walls extending upwardly from an upper surface 341 of the slide holder 116. The slide holder slot 312 of the slide holder 116 can be appropriately sized to correspond to a microscopy slide 118 to be received within the slide holder slot 312. For example, the microscopy slide 118 can have a standard size of 1″×3″. Alternatively, the slide holder slot 312 may be substantially larger than the microscopy slide 118 so that the edges of the slide 118 do not contact the opposing side walls 304 of the slide holder slot 312. The opposing sidewalls 304 and the interior rear walls 308 defining the slide holder slot 312 further define a frontal opening 316 of the slide holder slot 312. The frontal opening 316 allows a microscopy slide 118 to be displaced through the frontal opening 316 to be positioned within the slide holder slot 312; thus, a microscopy slide 118 can be displaced horizontally (parallel to the microscope base 100) through the frontal opening 316 to enter the slide holder slot 312.

In this example, opposing sidewalls 304 and interior rear wall 308 define the slide holder slot 312 having a length that is longer than a slide 118 to be received within the slide holder slot 312. The slide retaining member 320 can be positioned within the slide holder slot 312 at a position opposite the rear wall 308 and at a distance away from the rear wall 308 corresponding to a length of the slide 118 to be held within the slide holder slot 312.

In an alternate embodiment, the opposing sidewalls and rear wall can define a slide holder slot having a length that is shorter than the slide to be received within the slide holder slot. For example, when the slide 118 is received within the slide holder slot, the opposing sidewalls could extend only partially along the length of the slide. In this case, the slide retaining member can be positioned forward of the frontal opening defined by the opposing sidewalls and the rear wall at a distance away from the rear wall corresponding to a length of the slide to be held within the slide holder slot.

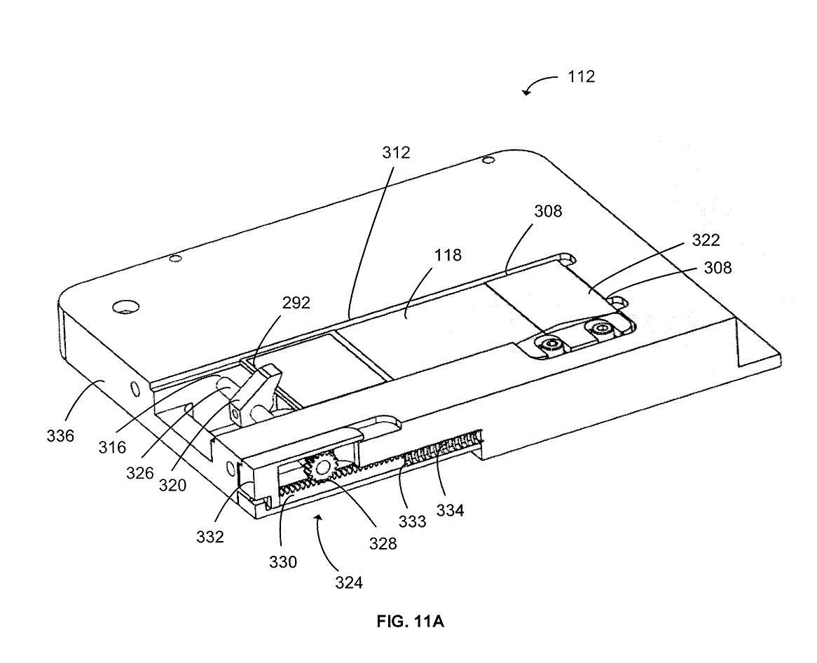

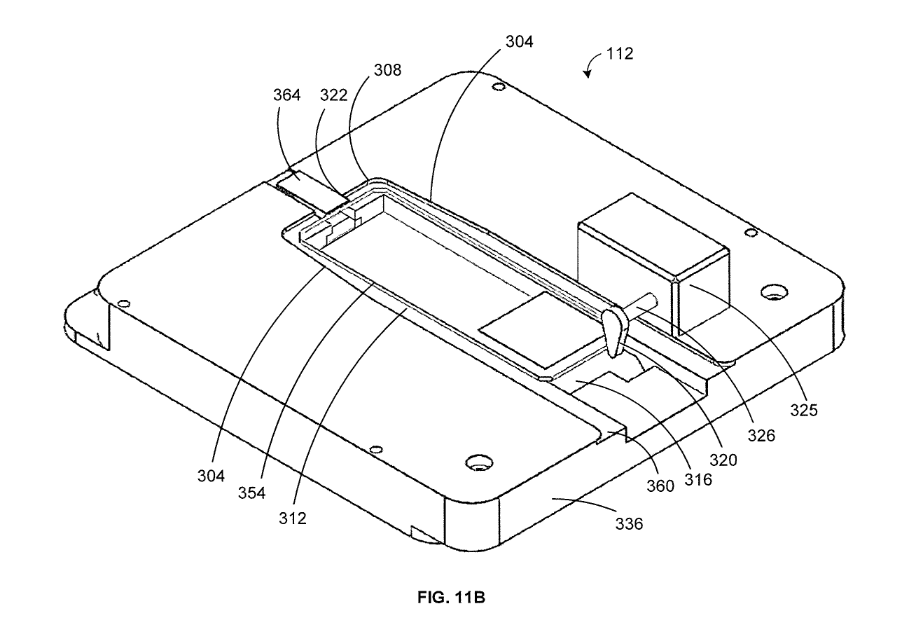

Referring now to FIG. 11A, therein illustrated is a perspective view of an exemplary slide holder 116 having a slide 118 being retained in the slide holder slot 312. In the upright position, the slide retaining member 320 engages and abuts against a rearward edge 292 of the slide 118 received within the slide holder slot 312. The forward edge 322 of the slide 118 abuts against the rear wall 308. Side edges of the slide 118 engage the opposing sidewalls 304 of the slide holder slot 312 such that the slide 118 is retained in a fixed position. It will be understood, that the slide 118 is in a fixed position with respect to the slide holder 116 but can be displaced when the slider holder 116 is displaced by the microscope stage 112.

Referring back to FIG. 10, the slide holder 116 is mounted on a movable portion 324 of the microscope stage 112. The slide holder 116 is displaceable between the slide loading position, a slide unloading position (which is the same or substantially the same as the slide loading position), and one or more slide retaining positions, including a slide viewing position. The slide loading position corresponds to a position of the slide holder 116 on the microscope stage 112 at which slides 118 can be loaded and unloaded from the slide holder slot 312 of the slide holder 116. The slide retaining positions correspond to a range of positions of the slide holder 116 wherein the slide 118 is retained in a fixed position within the slide holder slot 312 and relative to the slide holder 116. In the slide retaining position, the position of the slide 118 within the slide holder slot 312 is fixed and moves with displacement of the slide holder 116. Therefore movement of the slide holder 116 with the movable portion 324 of the microscope stage 112 will bring about a corresponding movement of the slide 118 retained within the slide holder slot 312. Movement of the slide holder 116 and the slide 118 retained therein allows alignment of different areas of a sample on the slide 118 with an active objective lens 132 of the microscope 20 for viewing and analysis.

The slide holder 116 is shown in FIG. 10 in slide loading position. As the slide holder 116 is displaced towards its slide loading position from one of its slide retaining positions, a slide retaining member 320 is pivoted to a lowered position to allow loading and unloading of a slide 118 to and from the slide holder slot 312 through the frontal opening 316. It will be understood that the lowered position may correspond to a position at a height that is higher than the upright position, so long as the frontal opening 316 of the slide holder slot 312 is unobstructed by the slide retaining member 320 when in the lowered position. As the slide holder 116 is displaced from its slide loading position to one of its slide retaining positions, the slide retaining member 320 is pivoted to its upright position to engage the rearward edge 292 of the slide 118 received in the slide holder slot 312 and to retain the slide in a fixed position within the slide holder slot 312.

Referring back to FIG. 11A, according to the exemplary embodiment, the slide retaining member 320 can be part of a slide locking mechanism 325. The slide locking mechanism 325 includes a rotatable rod 326 onto which the slide retaining member 320 is rotatably mounted. The rotatable rod 326 has at one end a pinion 328, which engages a rack portion 330 of an actuator 332. Translational displacement of the actuator 332 causes the rack portion 330 to be displaced longitudinally, causing rotation of the pinion 328. Rotation of the pinion 328 further causes rotation of the rotatable rod 326, which in turn causes pivoting of the slide retaining member 320 between its upright position and its lowered position. An inner end 333 of the rack portion 330 of the actuator 332 engages an inner biasing member 334, such as a spring. The biasing member 334 biases the actuator 332 towards a front end 336 of the slide holder 112. In this biased position of the actuator 332, rack portion 330 and the pinion 328 are engaged such that the slide retaining member 320 is pivoted to its upright position. Applying a force on an outer end of the actuator 332 towards the biasing member 334 displaces the rack portion 330 and rotates the pinion 328 and rotatable rod 326 such that the actuated retaining member is pivoted to its lowered position. FIG. 11 shows an exemplary slide holder 116 wherein the actuator 332 is in its biased position and the slide retaining member 320 is in its upright position.

According to an alternative embodiment, the slide retaining member 320 is actuated between its lowered and upright positions by an electric actuating device. For example, the slide locking mechanism 325 also includes a rotatable rod 326 which is rotated by an electric actuating device known in the art. For example, the electric actuating device is control based on a position of the slide holder 116 within the movable portion 324 of the microscope stage 112. As the slide holder 116 is displaced to its slide unloading position, the electric actuating device is controlled to actuate the slide retaining member 320 to its lowered position. Furthermore, as the slide holder 116 is displaced to its slide viewing position, the slide retaining member 320 is actuated to its upright position to retain the slide 112 within the slide holder slot 312.

Referring back to FIGS. 9 and 10, according to one exemplary embodiment, the microscope stage 112 may further include a stationary member 340 mounted onto a stationary portion 344 of the microscope stage 112. It will be understood that the stationary member 340 remains stationary as the slide holder 116 is displaced with the movable portion 324 of the microscope stage 112. The stationary member 340 has a protruding extension 346 that extends in a direction corresponding to the movement of the actuator 332. As the slide holder 116 is displaced towards its slide loading position, the extension 346 engages the actuator 332. In the intermediate position of the slide holder 116, the extension 346 contacts the actuator 332. Further displacement of the slide holder 116 towards its slide loading position causes the extension 346 of the stationary member 340 to apply a force on the outer end of the actuator 332 towards the biasing member 334, thereby causing the slide retaining member 320 to be pivoted to its lowered position. FIGS. 9 and 10 show the exemplary slide holder 116 having been displaced to its slide loading position and the slide retaining member 320 being pivoted to its lowered position.

During displacement of the slide holder 116 away from the slide loading position towards any one of its slide retaining positions, extension 346 disengages from the actuator 332. Since the slide retaining member 320 is biased towards its slide blocking position, disengagement of the extension 346 from the actuator 332 pivots the slide retaining member 320 back to its upright position, causing a slide 118 received within the slide holder slot 312 of the slide holder 116 to be retained in a fixed position within the slide holder slot 312.

Referring now to FIG. 11B, therein illustrated is a perspective view of a slide holder 116 according to an alternative exemplary embodiment in which the slide holder slot 312 is substantially larger than the microscopy slide 118 so that the lateral edges 354 of the slide 118 do not contact the opposing side walls 304 of the slide holder slot 312. The forward edge 322 may also be spaced from the rear wall 308 of the slide holder slot 312. For example, the slide 118 may be supported within the slide holder slot 312 by lip 360 extending from the slide walls 304 and rear wall 308. Furthermore, the slide 118 may be retained by engagement with the slide retaining member 320 and abutment of the forward edge 332 of the slide 118 with a rear clip 364.

As shown in the example, a portion of the rear clip 364 extends over a portion of the top surface of the slide 118 to restrict upward movement of the slide 118. Contact of the surface of the slide 118 with dispersion oil and a viewing objective of the microscope creates surface tension. Movement of the viewing objective may further cause an upward force on the slide 118. The rear clip 364 restricts this upward movement of the slide 118 due to the upward force.

Referring now to FIG. 12, therein illustrated is a plan view of the microscopy unit 10 having the microscope 20 and the slide loading system 30 being placed proximate one another in a configuration to allow automatic loading and unloading of slides between the cassette 208 and the slide holder 116. The microscope 20 can carry out automatic analysis of samples held on the slides of the cassette 208. When the slide loading system 30 and the microscope 20 are placed together, the cassette 208 is positioned such that in the slide loading position of the slide holder 116 the frontal opening 316 of the slide holder slot 312 is aligned with of an aligned slot of the front face 216 the cassette 208. Positioning of the cassette 208 can be adjusted by adjusting the position of the support bracket 204. The cassette 208 can be adjusted both in its height above the base 200 and its horizontal position within a plane parallel to the base 200. Adjustment of the positioning of the support members 204 supporting the cassette 208 can be carried out as a preconfiguration step of the slide loading system 30 when is to be used in combination with the microscope 20. Adjustment of the position of the cassette 208 allows the slide loading system 30 to be used with various types of microscopes having different dimensions.

Referring back to FIG. 1, the height of the support members 204 supporting the cassette 208 is adjusted so that vertical movement of the cassette 208 allows selective vertical alignment of each of the plurality of vertically stacked slots 212 of the cassette 208 with the slide holder 116 of the microscope stage 112. Preferably within its full range of vertical motion with respect to the slide loading base 200, each of the vertically stacked slots 212 can be selectively aligned in height with the slide holder 116.

The height of the loading arm 254 above the base 200 is adjusted to correspond to the height of the slide holder 116 above the base 100. In particular the height of the loading arm 254 is adjusted so that the extended arm member 270 corresponds to the height of the slide loader 116. Adjustment of the loading arm 254 may be carried out as part of a pre-configuration step of the slide loading system 30 when it is to be used in combination with the microscope 20. Adjustment of the height of the loading arm 254 allows the slide loading system 30 to be used with various types of microscopes 20 having different dimensions, such as different heights of the microscope stage 112.

Referring back to FIG. 12, the slide loading position of the slide holder 116 corresponds to a position on the microscope stage 112 wherein the frontal opening 316 of the slide holder slot 312 is aligned with the front face 216 of the cassette 208; the frontal opening 316 and the front face 216 of the cassette 208 is thus aligned in the x-axis direction 120. Due to alignment of the front opening 316 with the front face 216, a microscopy slide 118 being loaded to the slide holder 116 from the cassette 208 is displaced through the front opening 316 into the slide holder slot 312 of the slide holder 116.

According to exemplary embodiments, the slide loading position corresponds to the position wherein the frontal edge 336 of the slide holder 116 is pressed against the front face 216 of the cassette 208. According to such embodiments, the transverse members of the aligned slot of the cassette 208 and a bottom surface of the slide holder 116 form a continuous underlying surface supporting the displacement of the slide 118 between the cassette 208 and the slide holder slot 312 of the slide holder 116.

Alternatively, a gap can be formed between the front edge 336 of the slide holder 116 and the front face 216 of the cassette 208 when the slide holder 116 is in the slide loading position. In such a situation, guide walls 352 can be provided on the microscope stage 112 to define a channel 354 for guiding displacement of the slide 118 between the cassette 208 and the slide holder slot 312.

When the slide holder 116 is displaced to its slide loading position, displacement of the extended arm member 270 of the loading arm 254 from its retracted position to its extended position causes the microscopy slide 118 supported in the aligned slot of the cassette 208 to be ejected from the cassette 208 and displaced through the frontal opening 316 into the slide holder slot 312.

According to the exemplary embodiment wherein the forward edge 282 of the gripping fingers abuts the rearward edge 292 of the microscopy slide 118, the extended arm member 270 abuts against the microscopy slide 118 when pushing the slide 118 through the cassette 208 into the slide holder slot 312. Subsequent displacement of the extended arm member 270 in the rearward direction away from its extended position causes the extended arm 240 to disengage from the microscopy slide 118. Similarly, when the microscopy slide 118 is received in the slide holder slot 312, movement of the slide holder 116 also causes disengagement of the slide 118 from the extended arm member 270. For example, the extended arm member 270 is displaced forwardly to its extended position corresponding to a position where the slide 118 will be sufficiently received within the slide holder slot 312 such that pivoting of the slide retaining member 320 will cause the slide to be retained within the slide holder slot 312.

According to the exemplary embodiment wherein the slide 118 is to be frictionally gripped between the gripping fingers during forward displacement of the extended arm member 270, the cassette 208 is first adjusted to a first height whereby the microscopy slide 118 is prevented from exiting the cassette 208 by a blocking element. For example, at some heights, the front wall 220 acts as the blocking element to prevent exiting of the microscopy slides 118. When the cassette 208 is adjusted to the first height, displacement of the extend arm member 270 of the loading arm 254 from its retracted position to its extended position causes the slide 118 of an aligned slot to abut against the blocking element, which further causes a force to be exerted on the gripping fingers. Accordingly, the upper and lower members 296 and 298 are displaced to then grip, or pinch, the microscopy slide 118. The cassette 208 is then adjusted to a second height whereby the microscopy slide 118 is unobstructed by the blocking element and can be displaced from the cassette 208 into the slide holder slot 312 of the slide holder 316.

After the slide 118 to be analyzed is received within the slide holder slot 312 of the slide holder 116, the slide holder 116 can be moved away from its slide loading position to one of its slide retaining positions. For example, the slide holder 116 can be moved away from the slide loading position to align the sample of the slide 118 with an active objective 132 of the microscope 20. Analysis of the sample of the slide can then be carried out. After analysis of the sample is completed, the slide holder 116 can be displaced from back to the slide loading position for unloading of the slide 118 from the slide holder slot 112 of the slide holder 116.

According to various exemplary embodiments, the extended arm member 270 of the loading arm 254 remains in its extended position during analysis of the slide 118. After being returned to its slide loading position, the rearward edge 292 of the slide 118 can be gripped by gripping fingers of the extended arm member 270. The extended arm member 270 can be further displaced in a forward direction slightly beyond its extended position such that the upper member 296 and lower member 298 of the gripping fingers grip the slide 118. Forward displacement of the gripping fingers of the extended arm member 270 beyond its extended position causes the forward edge 282 of gripping fingers to exert a forward force on the rearward edge 292 of the slide 118. This forward force causes the forward edge of the slide 118 to abut against the rear wall 308 of the slide holder slot 312. A further forward force from the forward edge 282 of the extended arm member 270 results in a counterforce from the rearward edge 292 of the slide 118 to be exerted onto the spring member of the upper and lower members 296, 298 of the gripping fingers of the extended arm member 270, thereby forcing the upper and lower members apart and positioning the rearward edge 292 of the slide 118 between the two members 296, 298. A biasing force of the spring member towards the other member causes gripping or pinching of the slide 118. After the slide 118 is gripped by the gripping fingers of the extended arm member 270, the extended arm member 270 can be rearwardly displaced from its extended position towards its retracted position. This displacement of the extended arm member 270 results in the slide 118 being gripped by the gripping fingers and being pulled through the front opening 316 away from the slide holder slot 112 through the front face 216 of the cassette 208 into the aligned slot of the cassette 208. Further displacement of the extended arm member 270 towards its retracted position results in repositioning of the slide 118 within the aligned slot 212 and disengagement of the extended arm member 270 from the cassette 208.

Alternatively, instead of (or in combination with) the further forward displacement of the extended arm member 270 beyond its extended position, the slide holder 116 could be displaced in the direction of the cassette 208 slightly beyond its slide loading position. Such displacement causes the forward edge 282 of the extended arm member 270 to engage the rearward edge 292 of the slide 118 and to exert a forward force on the rearward edge 292 of the slide 118. Since the forward edge of the slide 118 abuts against the rear wall 308 of the slide holder slot 312, further force of the slide holder 116 towards the cassette 208 results in a counterforce from the slide 118 onto the spring member of the upper and lower members 296, 298 of the gripping fingers of the extended arm member 270, thereby forcing the upper and lower members apart and positioning the slide 118 between the two members 296, 298. A biasing force of the spring member towards the other member causes gripping or pinching of the slide. After the slide is gripped by the gripping fingers of the extended arm member 270, displacement of the extended arm member 270 from its extended position towards its retracted position results in the slide being gripped by the gripping fingers and being pulled through the front opening 316 away from the slide holder slot 112 through the front face 216 of the cassette 208 into the aligned slot of the cassette 208. Further displacement of the extended arm member 270 towards the retracted position results in depositing of the slide 118 within the aligned slot 212 and disengagement of the extended arm member 270 from the cassette 208.

According to various exemplary embodiments, the slide loading system 30 and the microscope 20 can each include a port for connection with an external controller. Alternatively, one or both of the microscope slide loading system 30 and the microscope 20 can have an internal controller for controlling various components thereof. The external controller, or internal controllers can control various components of the microscope slide loading system 30 and the microscope 20 to operate in combination.

The controllers may be implemented in hardware or software, or a combination of both. It may be implemented on a programmable processing device, such as a microprocessor or microcontroller, Central Processing Unit (CPU), Digital Signal Processor (DSP), Field Programmable Gate Array (FPGA), general purpose processor, and the like. In some embodiments, the programmable processing device can be coupled to program memory, which stores instructions used to program the programmable processing device to execute the controller. The program memory can include non-transitory storage media, both volatile and non-volatile, including but not limited to, random access memory (RAM), dynamic random access memory (DRAM), static random access memory (SRAM), read-only memory (ROM), programmable read-only memory (PROM), erasable programmable read-only memory (EPROM), electrically erasable programmable read-only memory (EEPROM), flash memory, magnetic media, and optical media.

According to some exemplary embodiments, a plurality of cassettes 208 may be provided. The plurality of cassettes 208 can be positioned side-by-side along the y-axis direction 124. The slide loading system 30 can include a cassette moving unit for moving the cassettes 208 along the y-axis direction 124. The cassette moving unit can selectively align each of the plurality of cassettes 208 with the loading arm 254 to interact with the loading arm 254. For example, after the slides loaded in a first of the plurality of cassettes 208 are analyzed using loading and unloading of the slides with the loading arm 254, the cassette moving unit moves the cassettes in the y-axis direction 124 so that a second of the plurality of cassettes 208 is aligned with the loading arm 254 and loading and unloading of the slides of the second cassette 208 can be performed.

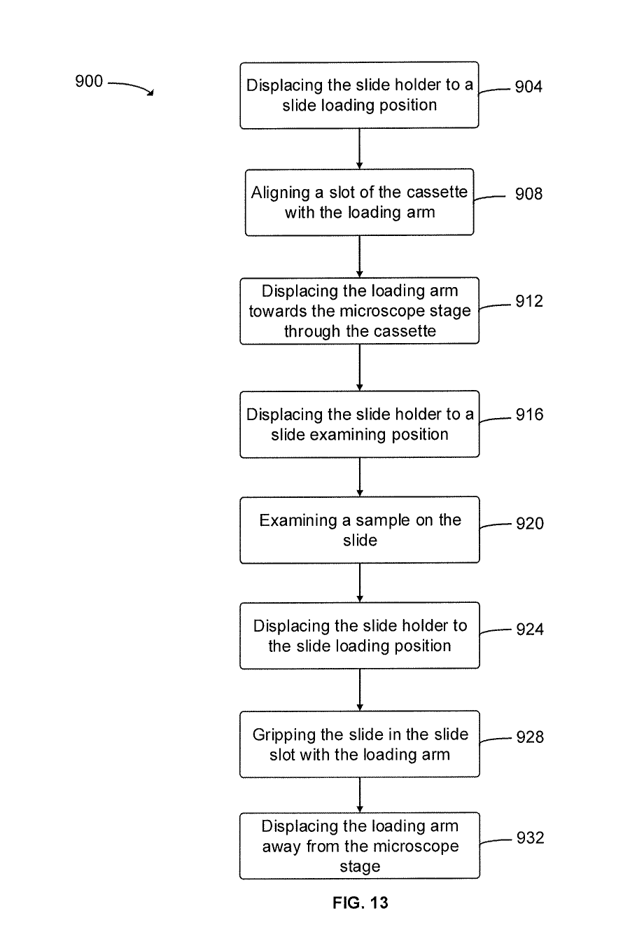

Referring now to FIG. 13, therein illustrated is a schematic diagram of the steps of an exemplary method 900 for carrying out automated slide loading and unloading and analysis of samples placed on a batch of the plurality of slides. The steps of method 900 can be carried out, for example, by a controller sending commands to various components of the slide loading system 30 and the microscope 20.

Before carrying out exemplary method 900, one or more preconfiguration steps may be necessary, such as adjusting the position and height of the support members 204 and position and height of the motorized loading arm 254. The pre-configuration steps may be carried out by a trained technician using combination of computerized steps and manual steps.

Before carrying out the method 900, the microscopy slides 118 to be analyzed are prepared according to known slide preparation techniques. For example, samples to be analyzed are placed on the slides. The prepared slides are then inserted into the plurality of stacked slots of the cassette 208 and the cassette 208 is positioned within the support member 204 of the slide loading system 30.

At step 904 a slide holder of the microscope is displaced to its slide loading position. For example the slide holder 116 described herein is displaced by the movable portion 224 of the microscope stage 112 to its slide loading position wherein front opening 316 of the slide holder slot 312 is aligned with a front face 216 of the cassette 208.

At step 908, a first slide contained in the cassette 208 to be analyzed is selected. For example, selection of the slide to be analyzed includes displacing the cassette 208 vertically with respect to the base 200 to align one of the slots of the plurality of stacked slots 212 of the cassette 208 with the motorized loading arm 254. During this step the motorized loading arm 254 is maintained in its retracted position disengaged from the cassette 208. It will be understood that the order of steps 904 and 908 can be interchangeable or the two steps can be carried out substantially simultaneously.

At step 912, a first slide is ejected from the cassette 208 and loaded onto the slide holder. For example, the third motor 266 of the motorized loading arm 254 can be controlled to cause the extended arm member 270 to be displaced through the cassette 208 towards the microscope stage 112. As described above, this displacement pushes the first slide 118 in the aligned slot out of the cassette 208 onto the slide holder slot 312 of the slide holder 116.

At 916, the first slide is displaced to its slide examining position. For example the controller can control the microscope stage 112 to cause movement of the movable portion 224 to displace the slide holder 116 such that the sample on the slide 118 received within the slide holder slot 312 is aligned with an active objective 132 of the microscope 20.

At step 920, after the first slide is displaced to the slide examining position, the sample of the first slide is analyzed by the microscope 20. For example, the controller can carry out various steps controlling various components of the microscope 20 to capture an image of the sample. Image capturing may require controlling one or more of the amount of light projected onto the sample via controlling of the aperture of the diaphragm 108, selection of an objective lens 132 having an appropriate magnification via control of the microscope turret 128, controlling the focus of the image of the sample through micro-movements of the stage 112 or the objective 132, and the image capture device 136 to capture an image of the sample. The controller can further apply one or more image processing algorithms to extract information pertaining to the sample of the first slide 118.

At step 924, after examination of the sample of the first slide is completed, the first slide is displaced to its slide loading position. For example, the controller controls the microscope stage 112 to cause movement of the movable portion 324 to displace the slide holder 116. According to various exemplary embodiments where the stationary member 340 engages an actuator 332 of the slide holder 116 to cause the slide retaining member 320 to be pivoted to the slide access position when the slide holder 116 reaches its slide loading position, displacement of the slide holder 116 from the slide retaining position to the slide loading position can have a predefined path such that during travel over the predefined path the stationary member 340 engages and actuates the actuator 332.

At step 928, the extended arm member 270 grips first slide. For example, the controller controls the motor 266 of the motorized loading arm 254 to displace the extended arm member 270 in a forward direction slightly beyond its extended position to apply a force from the gripping fingers of the extended arm member 270 onto the rearward edge 292 of the slide 118. The counterforce from the forward edge 282 of the slide 118 causes gripping fingers, lower and upper member 296 and 298 to be forced apart and grip the slide 118 therebetween. Alternatively, the controller controls the microscope stage 118 to displace the slide holder 116 in the direction of the cassette 208 to apply a force from the rearward edge 292 of the slide 118 onto the gripping fingers of the extended arm member 270.

At step 932, the first slide is pulled from the slide holder slot 312 of the slide holder 116 into an aligned slot of the cassette 208. For example the controller controls the motor 274 of the motorized loading arm 254 to displace the extended arm member 270 in a rearward direction from its extended position to its retracted position. Displacement of the extended arm member 270 in combination with gripping of the slide 118 between the gripping fingers pulls the first slide 118 through the front face 216 of the cassette 208 to reinsert the slide 118 into the cassette 208. Further displacement causes the forward edge of the first slide 118 to abut against an inner surface of the rear wall 228 of the cassette 208 further causing the slide 118 to be disengaged from the gripping fingers and deposited within the aligned slot 212 of the cassette 208.

Steps of method 900 can be repeated for a plurality of slides being held within the cassette 208. When repeating steps of method 900, step 904 of displacing the slide holder to a slide loading position may not need to be performed. For example, after returning the slide holder 116 to its slide loading position in order to reinsert the first slide 118 into the cassette 208, the slide holder 116 is already properly positioned to receive a second slide to be analyzed. In this case, the method can proceed to step 908 to displace the cassette 208 vertically to align another slot 212 with the slide holder 116 and to insert a second slide onto the slide holder 116 to be analyzed.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A microscopy slide loading system comprising:
a motorized cassette having a plurality of stacked slots for supporting microscopy slides; and
a motorized loading arm being displaceable between a retracted position and a loading position, during displacement from the retracted position to the loading position the loading arm projecting at least partially through an aligned slot of the cassette to displace a slide positioned therein to eject the slide from the cassette.

2. The microscopy slide loading system of claim 1, wherein the cassette has an at least partially open front face, an at least partially open rear face; and wherein in the retracted position the loading arm is disengaged from the cassette and in the loading position the loading arm projects through the rear face, the aligned slot of the cassette and the front face.

3. The microscopy slide loading system of claim 1, wherein the slide positioned in the cassette is ejected through the front face of the cassette.

4. The microscopy slide loading system of claim 1, wherein the loading arm is displaceable transversely to the stacked direction of the stacked slots of the cassette.

5. The microscopy slide loading system of claim 1, wherein during displacement from the loading position to the retracted position the loading arm pulls a slide external to the cassette into the aligned slot of the cassette to insert the slide into the cassette.

6. The microscopy slide loading system of claim 1, wherein a forward portion of the loading arm comprises gripping fingers for engaging a microscopy slide.

7. The microscopy slide loading system of claim 6, wherein the gripping fingers comprise an upper member and a lower member, at least one of the upper member and a lower member being a spring member biased towards the other of the upper member and lower member.

8. An automated microscope system comprising:
the microscopy slide loading system of claim 1, and
a microscope having a slide holder and a motorized microscope stage for displacing the slide holder between a slide loading position and a slide retaining position, the slide holder having a slide holder slot having a frontal opening defined by opposite side walls, a rear wall and an slide retaining member, in the slide loading position the slide retaining member being actuated to a first position to allow loading and unloading of a slide through the frontal opening and in the slide retaining position the slide retaining member being actuated to a second position to retain a loaded slide in the slide holding slot.

9. The automated microscope system of claim 8, wherein in the slide retaining position the slide retaining member engages a side of a slide positioned in the slide slot to retain the slide in the slide holder slot.

10. The automated microscope system of claim 8, wherein the slide retaining member is pivotally mounted on the slide holder and coupled to an actuator, wherein displacement of the actuator causes the slide retaining member to be pivoted between its first position and its second position.

11. The automated microscope system of claim 10, wherein the stage holder is mounted on a motorized movable portion of the microscope stage and a stationary member is mounted to a stationary portion of the microscope stage; and wherein during displacement of the slide holder to the slide loading position the stationary member engages and displaces the actuator to cause the slide retaining member to be pivoted to the first position.

12. The automated microscope system of claim 11, wherein during displacement of the slide holder to the slide retaining position, the actuator is displaced and the slide retaining member is pivoted to the second position.

13. The automated microscope system of claim 8, wherein the slide loading position corresponds to a position proximate an edge of the microscope stage and the slide retaining position corresponds to a position for examining the slide supported in the slide holder slot with an objective of the microscope.

14. The automated microscope system of claim 8, wherein in the slide loading position the frontal opening of the slide holder slot is aligned with the loading arm and wherein during displacement of the loading arm from the retracted position to the loading position the loading arm pushes a slide through the frontal opening to position the slide in the slide holder slot.

15. The automated microscope system of claim 8, wherein a forward force of the loading arm on a front edge of the slide in the slide holder slot creates a counterforce in a rearward direction on the gripping fingers of the loading arm whereby the spring member is forced away from the other member.

16. A microscope stage comprising:
a slide holder portion having a slide holder slot having a frontal opening defined by opposite side walls, a rear wall and a slide retaining member; and
a motorized movable portion for displacing the slide holder portion between a slide loading position and a slide retaining position, in the slide loading position the slide retaining member being actuated to a first position to allow loading and unloading of a slide in the slide holder slot through the frontal opening and in the slide retaining position the slide retaining member being actuated to a second position to retain a loaded slide in the slide holding slot.

17. The microscope stage of claim 16, wherein in the slide retaining position the slide retaining member engages a side of a slide positioned in the slide holding slot to retain the slide in the slide holder slot.

18. The microscope stage of claim 16, wherein the slide retaining member is pivotally mounted on the slide holder and coupled to an actuator, wherein displacement of the actuator causes the slide retaining member to be pivoted between its first position and its second position.

19. The microscope stage of claim 18, wherein the stage holder is mounted on a movable portion of the microscope stage and a stationary member is mounted on a stationary portion of the microscope stage, and wherein during displacement of the slide holder to the slide loading position the stationary member engages and displaces the actuator to cause the slide retaining member to be pivoted to the first position.

20. The microscope stage of claim 19, wherein during displacement of the slide holder to the slide retaining position, the actuator is displaced and the slide retaining member is pivoted to the second position.

21. The microscope stage of claim 16, wherein the slide loading position corresponds to a position proximate an edge of the microscope stage and the slide retaining position corresponds to a position for examining the slide supported in the slide holder slot with an objective of the microscope.

22. A method for loading and unloading slides to and from a microscope, the method comprising:
aligning a first slot of a cassette holding a first slide to be analyzed with a loading arm;
displacing the slide holder of a microscope stage to a slide loading position to align a front opening of a slide holder slot of the slide holder with the loading arm;
displacing the loading arm toward the microscope stage through a rear opening of the cassette to engage a slide supported in the aligned slot of the cassette and to push the slide through a front face of the cassette and through the front opening of the slide holding slot of the holder;
displacing the slide holder to a slide examining position to align the slide in the slide holding slot with an active objective of the microscope;
after examining the slide, displacing the slide holder of the microscope stage to the slide loading position to align the front opening of the slide holding slot of the slide holder with the loading arm;
gripping the slide with the loading arm;
displacing the loading arm away from the microscope stage to pull the slide into the aligned slot of the cassette; and
further displacing the loading arm away from the microscope stage to disengage the loading arm from the cassette.

23. The method of claim 22, further comprising aligning a second slot of the cassette holding a second slide to be analyzed with a loading arm.

24. A microscopy slide loading system, for loading microscope slides from a cassette having a plurality of slots supporting the microscope slides to a microscope having an automated movable stage, the slide loading system comprising:
a bracket for mounting the cassette;
an automated loading arm that can be displaced from a retracted position to an extended position;
an automated actuator for moving the cassette on the bracket to align a selected microscope slide supported in one of the slots of the cassette with the loading arm;
a slide holder mounted to the stage of the microscope;
the stage of the microscope being movable to a slide loading position;
a fixation for connecting the slide loading system to the microscope such that the slide holder is aligned to receive the selected slide as it is displaced outwardly from the cassette by the loading arm being displaced from its retracted position to its extended position when the stage is in the slide loading position;
the stage being movable to a slide viewing position, and subsequently movable to a slide unloading position that is substantially the same as the slide loading position;
the loading arm also having a retraction element for attaching to the slide so as to be able to pull the slide back from the slide holder into the cassette as the arm is returned to its retracted position when the stage is in the slide unloading position.

25. The slide loading system of claim 24, wherein the retraction element is activated by displacing the loading arm to a further extended position.

26. The slide loading system of claim 24, wherein the retraction element is activated by moving the stage toward the loading arm beyond the loading position.

27. The slide loading system of claim 24, wherein the slide holder includes a retainer for maintaining a loaded slide in position until it is to be unloaded back into the cassette.

28. The slide loading system of claim 27, wherein the retainer is movable.

29. The slide loading system of claim 28, wherein the retainer is activated by movement of the stage away from the loading position.
